(19) United States
(12) Patent Application Publication
(10) Pub. No.: US 2014/0004836 A1
(43) Pub. Date: Jan. 2, 2014

(54) SYSTEM AND METHOD TO DETECT HIDDEN MATERIALS USING AN IPHONE MOBILE TELEPHONE

(71) Applicant: Michael George Workman, Cape Canaveral, FL (US)

(72) Inventor: Michael George Workman, Cape Canaveral, FL (US)

(73) Assignee: ABION LLC, Cocoa Beach, FL (US)

(21) Appl. No.: 13/908,868

(22) Filed: Jun. 3, 2013

Related U.S. Application Data
(60) Provisional application No. 61/689,336, filed on Jun. 4, 2012.

(51) Int. Cl. G01N 29/04; H04W 4/16

(52) U.S. Cl. CPC G01N 29/04; H04W 4/16
USPC 455/414.2; 73/584

(57) ABSTRACT

A system and method using an iPhone cellular telephone to detect hidden materials, or contraband, in an automobile by measuring vibration. The mathematical formula frequency of vibration uses the mass M which affects the vibration. As mass of solid surface changes, so does the vibration. If difference in the vibration is detected between the inspected vehicle and empty vehicle that is the baseline, it may indicate hidden materials or contraband. The iPhone mobile cellular telephone contains components needed to implement this system and method. An accelerometer. A vibrator. A touch screen display. A computer operating system, iOS that runs Objective C software. SQLite, a computer database. A computer network connection to the internet using a wireless network. A GPS sensor to provide the latitude and longitude location of the phone during testing The iPhone also provides an electrical power source using the phone battery, or wall outlet electricity.

This application claims the benefit of provisional patent application Ser. No. 61/689,336, filed 2012 Jun. 4 by the present inventor.

### BACKGROUND

### Prior Art

The following is a tabulation of some prior art that presently appears relevant:

U.S. Patents

| Pat. No. | Issue Date | Patentee |
|---|---|---|
| 5,068,883 | Nov. 26, 1991 | DeHaan, et al. |
| 8,428,217 | Apr. 23, 2013 | Peschmann |
| 8,054,203 | Nov. 8, 2011 | Breed, et al. |
| 5,449,864 | Sep. 12, 1995 | Beatty, et al. |

U.S. Patent Application Publications

| Publication Number | Publication Date | Applicant |
|---|---|---|
| 20110271738 | Nov. 10, 2011 | McGill, et al. |
| 20040232054 | Nov. 25, 2004 | Brown, et al. |
| 20100177868 | Jul. 15, 2010 | Smith |

### BACKGROUND OF THE INVENTION

This System and Method provides a means to identify if there are hidden materials within a container, such as an automobile. Automobiles are often used for transporting illegal and contraband materials such as illegal drugs, cash from illegal activities, untaxed goods, counterfeit goods, and other contraband. Automobiles can also be used as weapons when explosive materials are hidden within them. This System and Method provides a means to identify if there are hidden materials within an automobile, and provides advantages over the prior art.

Several methods use radiation to examine a vehicle and determine if there are hidden materials. One system uses dual energy X-ray CT scanning to examine objects and determine what kinds of materials are within the objects, including objects that are vehicles. The disadvantages of this system is that the apparatus to generate the dual energy is large and not readily mobile, and requires considerable effort to move from one location to another. Also this system requires a large and significant source of electricity to power the dual energy X-ray generating devices that are used to examine the objects. The dual energy X-ray radiation also poses a health risk to persons who may be exposed to it, so that it cannot be used to examine a vehicle if there are persons within the vehicle.

Another method uses a first substructure and a second substructure and the vehicle must be positioned between the substructures, and then ultrasonic sound is used to examine the vehicle and determine if there are objects within the vehicle. The disadvantage of this method is that it requires two separate structures that the vehicle must be driven between and the substructures themselves are not readily mobile and easy to carry by a single person.

One method used to detect contraband uses Infrared Light to examine a vehicle and detect certain analytes of material, Analyte Detection with Infrared Light. The infrared light is tuned to excite certain kinds of particles so that it can be configured to detect certain materials, such as those contained within explosive substances. To examine an entire vehicle at one time, requires a large number of infrared light sources as part of a large apparatus. The method is not readily mobile. Also this method cannot be used to determine if there are materials hidden within the hollow cavities of an automobile, such as the hollow space within the door of an automobile, where infrared light cannot penetrate without dismantling the door.

Another method, Vehicle Security Inspection System, uses a large apparatus and a conveyer belt that the vehicle is driven upon and then the conveyer belt is used to ferry the automobile past sensors of different types to detect contraband within the automobile. The permanent installation version of this method is large and not readily moveable from one location to another. A conveyer belt large enough to transport and carry an entire automobile cannot be carried by a single person from one location to another.

One method, Motor Vehicle Screening Apparatus and Method, relies on large, heavy machines to weigh the vehicle and compare the weight of the vehicle to that of an empty vehicle of the same type, to determine if the vehicle has additional materials in it. This is a large machine not readily moveable and takes a significant amount of time to prepare and deploy. The method uses an apparatus that is not readily mobile, and cannot be moved from one location to another by a single person.

Also, all of these methods do not automatically come with a connection to the internet that allows the methods to retrieve and send data to a central computer server connected to the internet. A significant effort would be required to setup these methods to report the results of their deployment and usage to a central computer server connected to the internet.

### SUMMARY OF THE INVENTION

The object of this invention is to provide a system and method to determine if there are hidden materials within an automobile, or vehicle. It uses an Iphone mobile telephone, manufactured by Apple Inc., to implement the system and method, and a custom software application that runs on and controls the Iphone telephone.

By measuring the frequency of vibration with which a surface of the automobile vibrates, and comparing it to the frequency of vibration for that particular kind of automobile when it is empty of hidden materials, it can be determined if there are hidden materials within the automobile. The mass of an object affects the frequency of vibration, when an automobile has hidden materials within it, it adds mass to the automobile and causes the frequency of vibration of different surfaces of the automobile to change.

The Iphone contains all of the necessary components to implement this system and method, A computer processor chip and memory chips that allow a computer operating system and software to run on the phone. An accelerometer, an electronic device that measures vibration and motion. A vibrator that cause the Iphone to vibrate. A computer operating system, iOS, that manages the components of the Iphone and allows for the development of custom software using the Objective C programming language. SQLite, a computer database library that allows for the storage and retrieval of data using a software application. A touch screen display that allows the Iphone user to control the Iphone and software that runs on it. A Global Positioning System (GPS) sensor that allows the latitude and longitude location of the Iphone to be determined. A connection to the internet using the cellular communications network the Iphone uses, and/or a connection to the internet using a wireless internet router, known as WiFi. A battery that serves as the source of electricity for all of the components within the Iphone, and also the Iphone can be connected to a wall outlet source of electricity.

The Iphone is small and lightweight, and can be transported by a single person without difficulty. It also has a battery that allows for the Iphone to be used for several hours when fully charged, without the need of being plugged in to a wall outlet source of electricity.

This system and method is implemented using the Iphone by the following steps (a) Data about the automobile being inspected is entered into the Iphone using the touch screen of the Iphone (b) a long side of the phone is placed against the part of the automobile being inspected (c) User clicks a button on the touch screen of the phone that causes the phone to vibrate and apply energy to the surface of the automobile, and cause that surface to vibrate (d) The accelerometer contained within the phone measures the vibration (e) The custom phone software compares the vibration value to that of the vehicle when it is empty and determines if there is a significant difference, that may indicate hidden materials (f) A simple PASS or FAIL message is displayed to the user depending on the results of the test (g) The results of the test are stored by the application software in a computer database and reported by webservice to the central internet server, where the deployment of this system and method across a geographic area can be monitored from a central location.

### BRIEF DESCRIPTION OF THE DRAWINGS, SOURCE CODE FILES LISTED ALSO

FIG. 1—a flowchart that shows the basic steps of using this system and method

FIG. 2—a flowchart that shows the process of when the phone vibrates and measures vibration

FIG. 3—a flowchart that shows the process when one of the checkbox options is checked

FIG. 4—a flowchart that shows the process of the update option of the admin screen

FIG. 5—a flowchart that shows the process of the clear readings option of the admin screen

FIG. 6—a flowchart that shows the process of the import baseline option of the admin screen

FIG. 7—a flowchart that shows the process of the import simple baseline option of the admin screen

FIG. 8—the button options of the start screen of the software application

FIG. 9—the button options of the auto color screen

FIG. 10—the button options of the auto type screen

FIG. 11—the button options of the auto part screen

FIG. 12—the button options of the test auto screen

FIG. 13—the button options of the admin login screen

FIG. 14—the button options of the administration screen

### DETAILED DESCRIPTION OF THE INVENTION

The following description is of the best mode presently contemplated of practicing the invention.

Solid surfaces, including surfaces of metal, vibrate with a frequency of vibration when energy is applied to that surface, such as a tap or strike with another solid object. The following mathematical formula shows how the exact frequency of vibration, fn, is determined, the formula uses the number value K, the elastic constant, and the mass of the object, M, to determine the exact frequency of vibration. When K stays the same for the particular surface but mass M changes, the frequency of vibration also changes. Thus changes in mass of an object also cause changes in the frequency of vibration of that particular object. This is the basis of this invention and how it is used to determine if there are hidden materials within an object, when the object is an automobile.

$${f}_{n} = \frac{1}{2 π} \sqrt{\frac{K}{M}}$$

By applying energy to the surface of an automobile, and causing that surface to vibrate, then measuring the frequency of vibration, and then comparing that frequency of vibration to the known frequency of vibration for that automobile when the automobile is empty of hidden materials or contraband, it can be determined if there are hidden materials or contraband within the automobile. Most automobiles contain hollow cavities where materials can be hidden, such as the hollow cavity between the outside surface of an automobile door and the inside surface of that automobile door, hidden materials in this hollow cavity affect the mass M of the surface of the door, causing it to vibrate with a different frequency than when that hollow cavity is empty. The same process can be applied to other parts of the automobile. Also, when a significant object of a certain size is contained anywhere within the automobile, it will affect the frequency of vibration of all surfaces of the automobile. This is the basis of this system and method and how it uses vibration to determine if there are hidden materials within an automobile.

The Iphone mobile telephone provides all of the components needed to implement this system and method. The components are listed here. A computer processor chip and computer memory chips. An accelerometer. An electronic vibrator. A touch screen interface. A computer operating system. A computer database. A global positioning system (GPS) sensor. Electronic components that connect to the internet through cellular communications network. Electronic components that connect to the internet through a wireless internet router, or Wifi. A custom software application that allows the user of the Iphone to examine an automobile and determine if there are hidden materials within the automobile by comparing the vibration value of the surface of an automobile to the known vibration value of an automobile free of contraband and hidden materials.

The Iphone mobile telephone contains a computer processor chip and computer memory chips that allow for software to operate on the phone and manage all of the components of the phone. The Iphone has a computer operating system software installed on it called iOS that provides for many features on the phone, including the management of the components of the phone, making phone calls, sending text messages, allowing for users to interact with the operating system using a touch screen interface, and allows for the running of custom software applications that are written using the Objective C programming language, a derivative of the C programming language. Objective C software for the Iphone is created using the Xcode development environment and the Iphone software development kit (SDK) from Apple Inc. which requires the use of an Apple Mac or Macbook computer. Also an Iphone must be provisioned with a cryptographic key provided by Apple Inc. before software can be installed on the Iphone through a means other than the Apple App Store. This requirement can be avoided through a process called “jailbreaking”, in which the protective measures of an Iphone installed by Apple are sidestepped. Objective C software can be created without the use of Xcode, using the gcc compiler and a “j ailbroken” Iphone, but the software libraries and application program interfaces (api's) available on an Iphone are not provided as part of the gcc compiler.

The Iphone contains an accelerometer, an electronic sensor that measures vibration and motion. This electronic component can be accessed using Objective C software. The rate of vibration measured by the accelerometer can be read by the software and stored in a variable to be used within the software. All Iphones contain an accelerometer.

The Iphone contains an electronic vibrator that causes the Iphone to vibrate. All Iphones contain an electronic vibrator. Normally this is used to put the Iphone in a “silent” mode so that the phone does not make a noise when receiving an incoming call or incoming text message, instead the phone vibrates. This electronic component can be accessed and controlled using Objective C software. It can be used to apply energy to the surface of an automobile and cause the surface of the automobile to vibrate.

The Iphone contains a touch screen interface which allows the user to interact and control the Iphone. Screens, or View Controllers, can be developed using Objective C and XML and customized to work with software running on the Iphone.

The Iphone contains a database library called SQLite, which allows for the creation of computer databases which are accessed and controlled using the Structured Query Language (SQL) computer language standard. SQLite databases allow for the storage and retrieval of computer data and can be implemented using the Objective C programming language.

The Iphone, except for the very first version of the Iphone, also contains a global positioning system (GPS) sensor that can determine the Latitude and Longitude location of the Iphone using the GPS Satellite network. Data from this GPS sensor can be accessed using Objective C software.

The Iphone contains components that allow it to connect to the internet through the cellular communications network that handles phone calls and text messages coming from and going to an Iphone. An Iphone can also connect to the internet through a wireless internet router where such a router is available and within proximity of the Iphone. This is often referred to as WiFi. Data can be sent and retrieved from the internet using Objective C software.

Before this system and method can be used to determine if hidden materials are contained within an automobile, a database must be built that contains the vibration values of empty automobiles to be used as the baseline for vibration comparisons. A part of this invention allows for this task to be done.

The vibration measurement of an empty automobile is called the BASELINE reading. For this invention, there are two kinds of baseline readings, the regular baseline reading, and the simple baseline reading. A regular baseline reading applies to a manufacturer/make of automobile, type of automobile, and part of automobile. A simple baseline reading applies to a type of automobile and part of the automobile, but is not differentiated by the manufacturer/make of the automobile. The regular baseline reading can be the empty vehicle vibration measurement for a chevrolet car door, where the simple baseline reading can be the empty vehicle vibration measurement for a car door, a simpler differentiation, and so is called the simple baseline.

The baseline and simple baseline readings are stored in the Iphone computer database. The regular baseline reading is stored in a database table called BASELINE, and the simple baseline reading is stored in a database table called SIMPLEBASELINE. These two tables have the following structure and columns.

### Baseline Table

### Columns:

ROWID, an integer value to identify single row of data that is automatically incremented with new data
MANUFACTURER, a text field containing the name of the automobile Manufacturer/Make
TYPE, a text field containing the type of automobile (car, sport utility vehicle, van, or truck)
PART, a text field containing the auto part (door, bumper, quarter panel, trunk, fuel tank, dashboard)
BASELINEREADING, a real field that stores a floating point number, for the frequency of vibration

### Simplebaseline Table

### Columns:

ROWID, an integer value to identify single row of data that is automatically incremented with new data
TYPE, a text field containing the type of automobile (car, sport utility vehicle, van, or truck)
PART, a text field containing the auto part (door, bumper, quarter panel, trunk, fuel tank, dashboard)
BASELINEREADING, a real field that stores a floating point number, for the frequency of vibration

The computer database used by this invention also has several other tables. A tabled called OWNERINFO that contains a KeyID, or a randomly generated number used to be the unique identifier of a particular phone. A table called TOLERANCE that is used to store the tolerance value of vibration measurements by the accelerometer. Not every measure of vibration of the surface of an automobile will be the exact same value, there will be a variance of measurements and the tolerance is used to determine the range of that variance. Also there is a database table called READINGS, which is used to store the information from a single test of an automobile. These tables have the following structure.

### Ownerinfo Table

### Columns:

ROWID, an integer value to identify single row of data that is automatically incremented with new data
KEYID, an integer number for the unique identifier for a particular phone

### Tolerance Table

### Columns:

ROWID, an integer value to identify single row of data that is automatically incremented with new data
TOLERANCE, a real value, a floating point number to be used as the variance of vibration values

### Readings Table

### Columns:

ROWID, an integer value to identify single row of data that is automatically incremented with new data
DATETIME, text field, the data and time of the test of the automobile
LATITUDE, real field, floating point number, latitude location of the phone during auto tes
LONGITUDE, real field, floating point number, longitude location of the phone during auto test
MANUFACTURER, text field, the manufacturer/make of the automobile being tested
COLOR, text field, the color of the automobile being tested
TYPE, text field, the type of automobile being tested (car, suv, etc.)
PART, text field, the part of automobile being tested (bumper, door, etc.)
AVERAGEREADING, real field, the average vibration of the auto surface during the test
PASSFAIL, text field, the results of the test of the auto, either PASS or FAIL.

The database tables are created and maintained in an Objective C class called DatabaseIO, which is used to contain all of the common database operations that will be performed on the database, and allows for reusability of software so software does not have to be duplicated needlessly each place in the software that it is used.

The steps to implement this system and method using the Iphone and the custom software application are listed in brief here, and then in more detail afterwards.
(1) Start the custom software application on the Iphone and select the Manufacturer/Make of the automobile.
(2) On the next screen, select the color of the automobile.
(3) On the next screen, click the button for the type of automobile.
(4) On the next screen, click the button for the part of the automobile being tested.
(5) On the next screen, place a long side of the phone against the part of the automobile being tested, click the INITIATE TEST button, hold the phone against the automobile until the phone has vibrated 4 times. Phone vibration causes the surface of the automobile to vibrate. Phone measures the value of the vibration.
(6) The value of the vibration is compared to the vibration value of an empty, contraband free automobile stored in the phone database, if there is a difference, it can indicate the presence of hidden materials or contraband within the automobile.
(7) The results of the test of the automobile are stored in the phone database and reported by webservice to a central server on the internet.

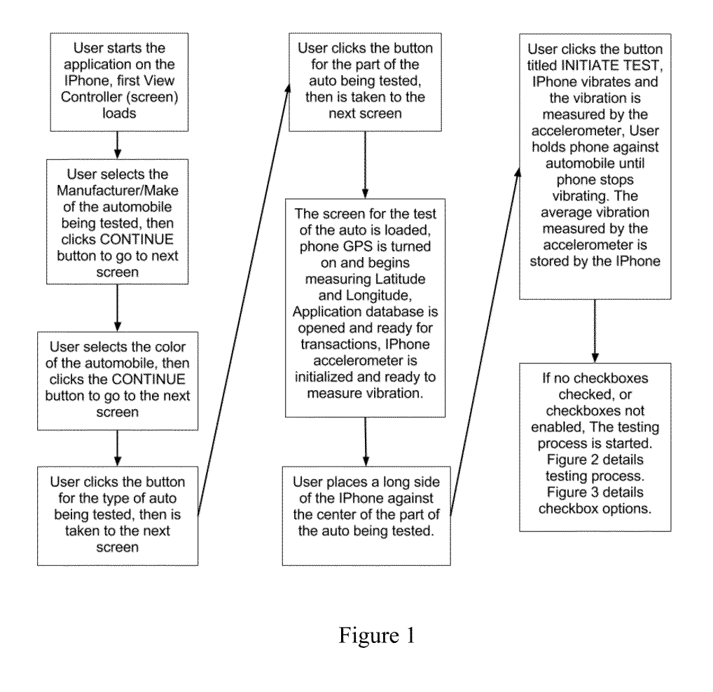

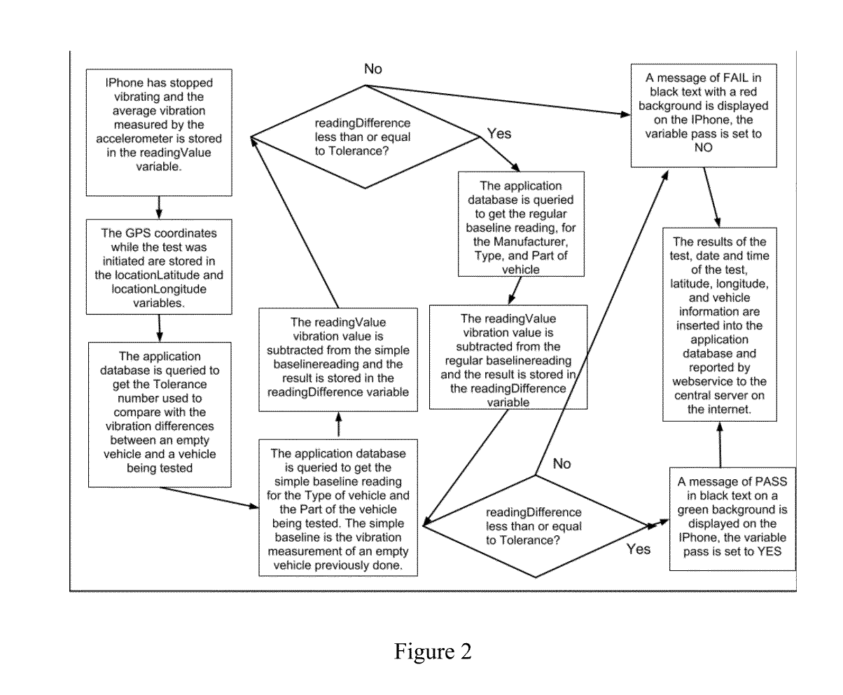

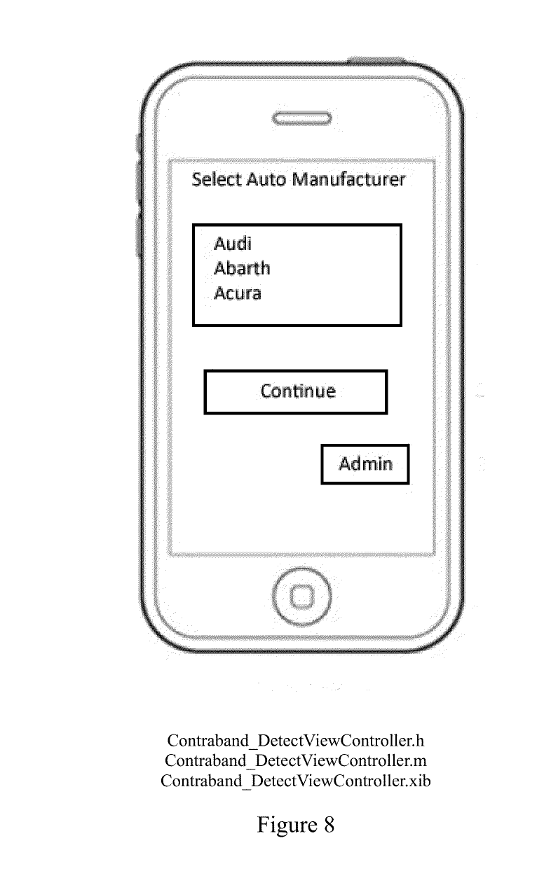

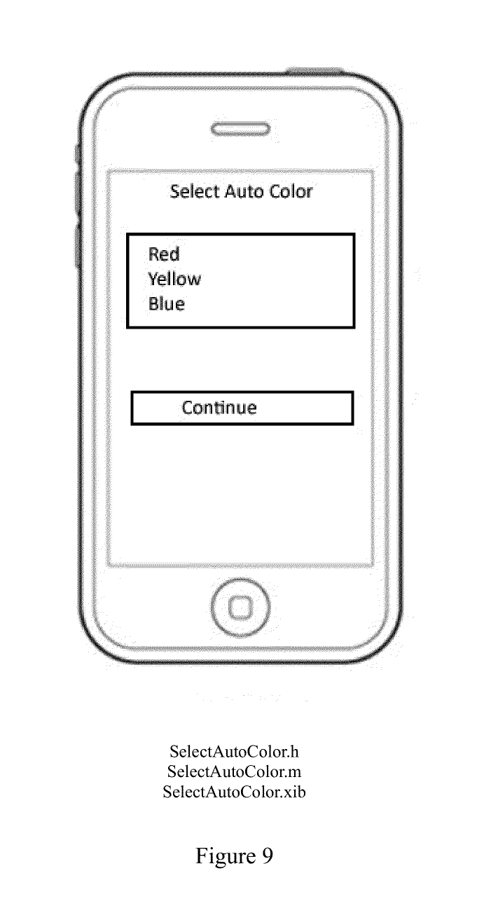

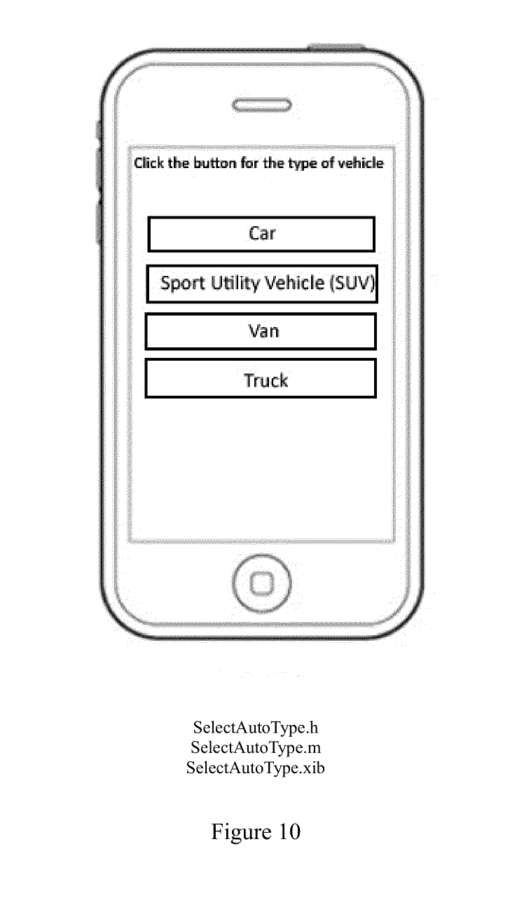

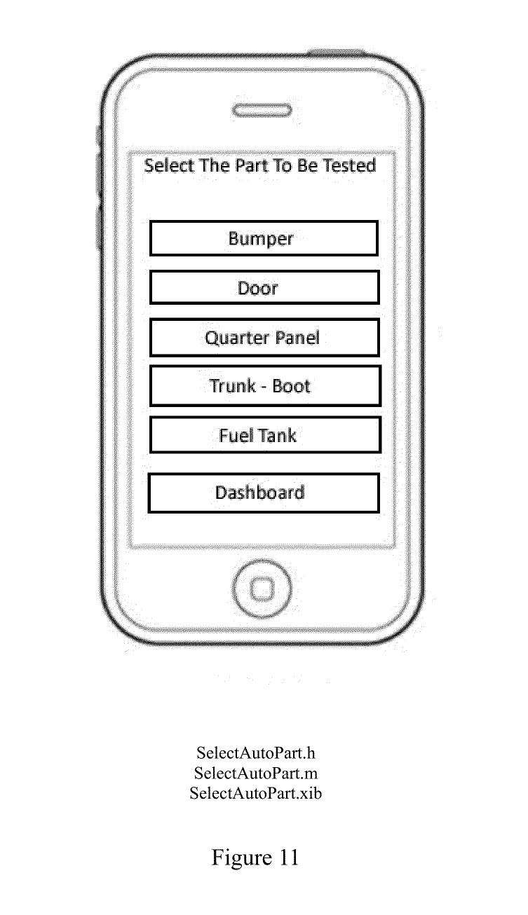

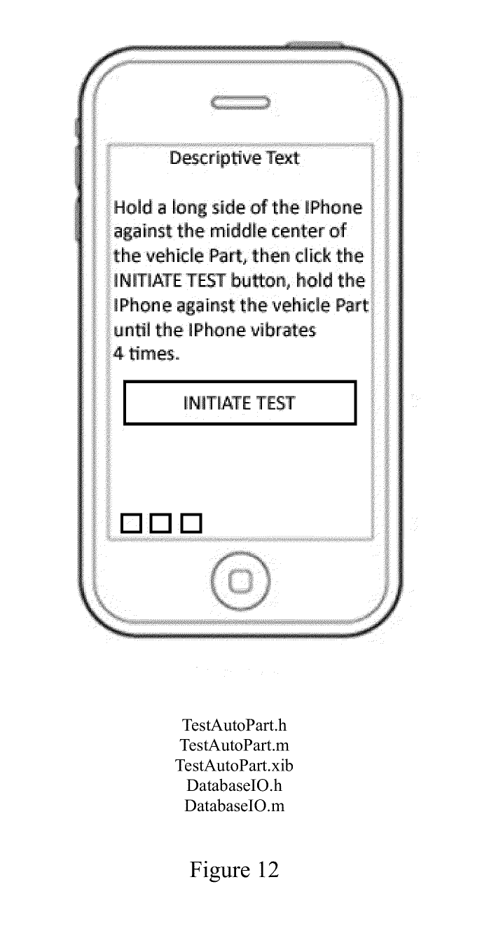

The detailed process using this invention to do a test of an automobile is composed of the following steps:
(1) start software application on the phone
(2) In the first screen of the software application, the user selects the Manufacturer/Make of the automobile from a picker user interface control, then clicks the continue button to go to the next screen. The manufacturer chosen by the user is stored in a string variable to be used by the application. The interface for this screen is shown in FIG. 8.
(3) The next screen of the software application, the user selects the Color of the automobile from a picker user interface control, then clicks the continue button to go to the next screen. The color chosen is stored in a string variable to be used by the application. The manufacturer chosen in the preceding screen is displayed as descriptive text at the top of the screen. The interface for this screen is shown in FIG. 9.
(4) This screen of the software application, the user clicks a button for the type of automobile being tested. The user is then taken to the next screen, the type of automobile is stored in a string variable to be used by the application. The manufacturer and color of the automobile chosen in the preceding screens is displayed as descriptive text at the top of this screen. The interface for this screen is shown in FIG. 10.
(5) This screen of the software application, the user clicks a button for the part of the automobile being tested. The user is then taken to the next screen of the application. The part of automobile chosen is stored as a string variable to be used by the application. The manufacturer, color, and type of vehicle chosen in previous screens are displayed as descriptive text at the top of this screen. The interface for this screen is shown in FIG. 11, which is for the button options displayed on this screen of the application.
(6) The user is now at the screen of the application where the actual test of the automobile will take place, steps 1-6 are detailed in the flowchart in FIG. 1. The next steps are detailed in the flowchart in FIG. 2. The user interface for this screen is shown in FIG. 12. The manufacturer, color, type, and part of the automobile are shown in descriptive text at the top of the screen. When this screen is opened, the database is also opened and ready for transactions, the GPS sensor is initialized and registers the latitude and longitude location of the phone and where the automobile test is taking place. The accelerometer is also initialized and ready to begin measuring vibration. On this screen of the application is a button titled INITIATE TEST (FIG. 12) and at the bottom of the screen are three checkboxes for checkbox options (FIG. 12). Checkbox options are detailed further on in this specification. The user then takes the phone and places a long side (either side) against the surface of the automobile part being tested. The user then clicks the button titled INITIATE TEST on this screen. A flag value variable is set to track when the accelerometer will measure vibrations, it is set to YES. In a separate thread of the software application, the phone is then commanded to vibrate 4 times by the software application, while the phone is vibrating, the average vibration value is measured by the accelerometer and stored in a variable for use by the software application, when the phone stops vibrating, the flag value variable for tracking vibration measurements is set to NO to signal the application to stop measuring vibration. The user can stop holding the phone against the automobile surface once it stops vibrating.
(7) If no checkbox options are checked, the software application then begins the process of comparing the measured vibration to the simple baseline and baseline readings to determine if there is a difference, indicating the presence of hidden materials or contraband. The database is accessed and a query is run to get the simple baseline reading for the type of automobile, and the part of the automobile being tested. A query is also run on the database to get the Tolerance value. The absolute value of the average vibration from the test is subtracted from the simple baseline reading, to arrive at the reading difference. If the reading difference is less than or equal to the tolerance, then the test is a PASS, if the reading difference is greater than the tolerance, the test is a FAIL. If the test is a FAIL, then step 8 is skipped and the application software goes directly to step 9.
(8) If the test of the average vibration results in a PASS when compared to the simple baseline reading, then the database of the application is checked to see if there is a regular baseline reading for the Manufacturer, Type and Part of automobile being tested. A select query is executed on the application database to determine if there is a regular baseline reading for the Manufacturer, Type, and Part of automobile. The average vibration value is then subtracted from the regular baseline reading to get the reading difference value.
(9) If the reading difference is less than or equal to the tolerance, then the test is a PASS and there is no hidden materials present in the part of that automobile that was tested. If the reading difference is greater than the tolerance, then the test is a FAIL, indicating the presence of hidden materials or contraband in the part of the automobile tested. If the test is a PASS the word PASS in black text with a green background is displayed to the user on the phone. If the test is a FAIL, the word FAIL in black text on a red background is displayed to the user on the phone.
(10) The next part of the test is to store the results of the test of the automobile in the computer database of the software application. An insert sql query is constructed to insert the Date and Time of the automobile test, the Latitude and Longitude of the automobile test, the Manufacturer, Color, Type, and Part of the automobile that was tested, the average vibration reading from the automobile test, and the results of the test PASS or FAIL. The insert query is then executed to insert the data into the database table READINGS.
(11) The next part of the test is to report the test by way of internet webservice to the central webserver computer. This is done by way of a REST webservice operation, if a connection to the internet is available by cellular network or by wireless internet router, then the report is executed and the Date and Time of the automobile test, the Latitude and Longitude of the automobile test, the Manufacturer, Color, Type, and Part of the automobile that was tested, the average vibration reading from the automobile test, and the results of the test PASS or FAIL are all reported to the central webserver computer. Also the KeyID of the phone is required as the unique identifier of the phone doing the webservice call. A confirmation of the internet webservice operation is displayed to the user on the phone.

A method by which the baseline readings of an empty automobile can be inserted into the application database can be done in one of two different ways. One way is to exercise one of the checkbox options on the bottom of the screen where the INITIATE TEST button is also located (FIG. 12), where the actual test of the automobile is executed. Another way is to use the administration screen of the application where an import of simple baseline and import of regular baseline readings can be executed by way of internet webservice.

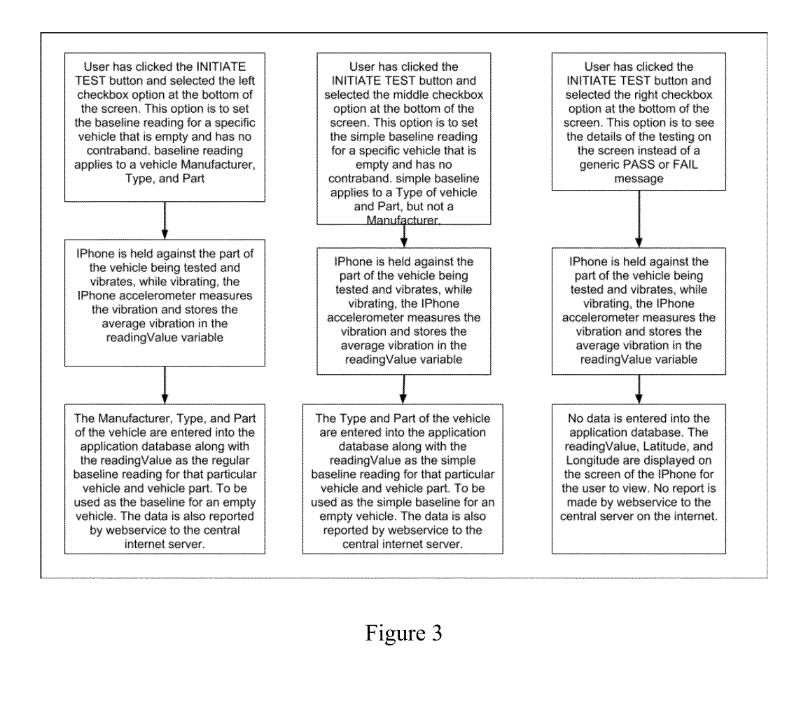

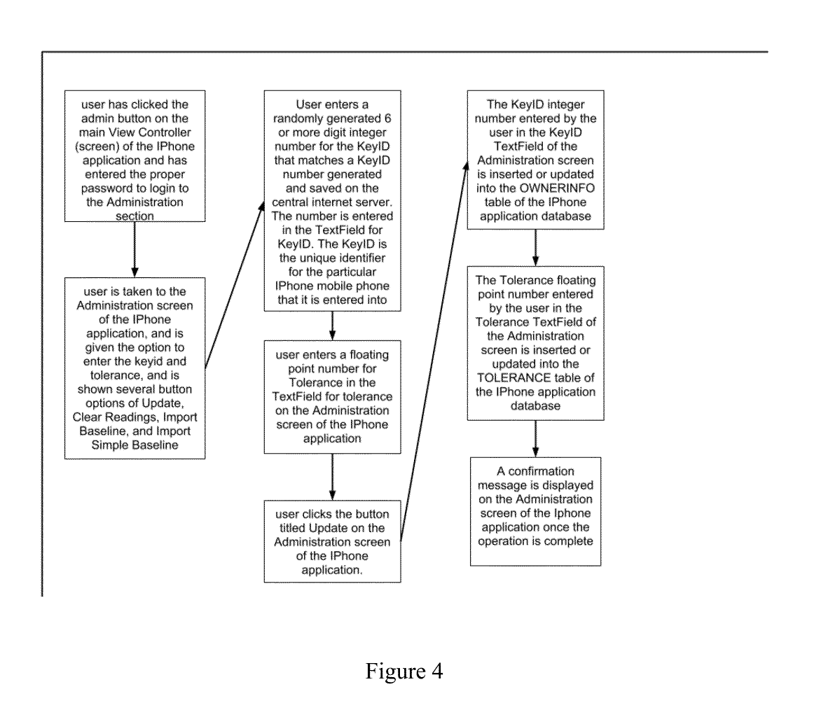

Baseline readings should only be set when there is absolute certainty that the automobile being tested is free of hidden or contraband materials. Checkbox options are outlined in the flowchart in FIG. 3. Administration screen options are detailed in the flowcharts in FIGS. 4-8.

When checkbox options are enabled and checked, no test of the automobile is done to determine if there is contraband or hidden materials in the automobile, instead the average vibration reading is used as a regular baseline and/or simple baseline reading (left and center checkbox options), or the average vibration value is displayed to the user instead of a generic PASS or FAIL message (right checkbox option).

During the test of the automobile, if the left checkbox option is checked, then the results of the test are used to set the regular baseline reading for that Manufacturer, Type, and Part of vehicle. The average reading of vibration measured while the phone was vibrating and was held against the surface of the automobile is placed into the application database as the regular baseline reading, for that particular Manufacturer, Type, and Part of automobile. If a baseline reading already exists in the database for that Manufacturer, Type, and Part of automobile, then an update operation is done on the database table BASELINE. If no record exists in the database for that Manufacturer, Type, and Part of automobile, then an insert operation is done on the database table BASELINE. When this checkbox option is checked, no test is done to determine if there is contraband or hidden material within the automobile.

During the test of the automobile, if the center checkbox option is checked, then the results of the test are used to set the simple baseline reading for that Type and Part of automobile. Simple baseline readings do not apply to a Manufacturer/Make of automobiles, only to a Type and Part of automobile. The average reading of vibration measured while the phone was vibrating and was held against the surface of the automobile is placed into the application database as the simple baseline reading, for that particular Type and Part of automobile. If a simple baseline reading already exists in the database for that Type and Part of automobile, then an update operation is done on the database table SIMPLEBASELINE. If no record exists in the database for that Type and Part of automobile, then an insert operation is done on the database table SIMPLEBASELINE. When this checkbox option is checked, no test is done to determine if there is contraband or hidden material within the automobile.

When both the left and the center checkbox options are checked, then the average vibration reading is used to be placed into both the BASELINE database table and also the SIMPLEBASELINE table as the regular and simple baseline readings.

When the right checkbox option is checked out of the three checkbox options at the bottom of the test automobile screen (FIG. 12), then the average vibration reading measured while the phone is vibrating and held against the surface of the automobile is displayed on the screen to the user. No test is done to determine if there is contraband or hidden materials in the vehicle by comparison with a regular or simple baseline reading. No message of PASS or FAIL is displayed to the user. No database operation is executed. No webservice operation is called.

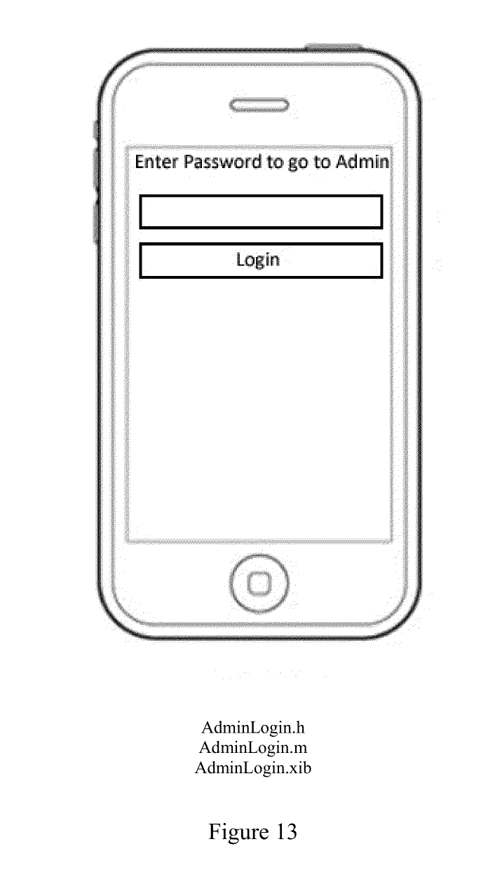

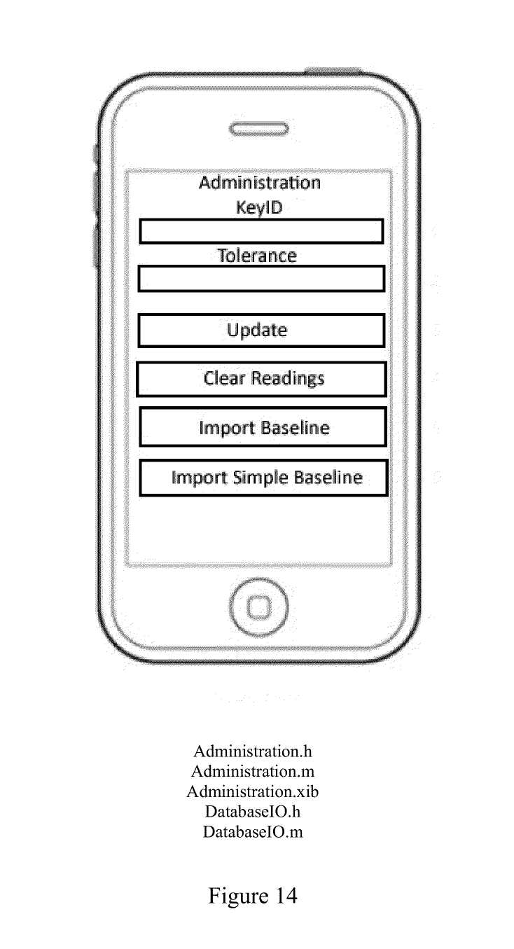

An administration screen is available as part of the software application as well. This part of the application is for persons responsible in a management and supervisory role in the deployment of this technology, referred to herein as admin user. It is not for the general users of the technology and system and method. For a user to get to the administration screen of the application, they simply click the button titled ADMIN on the first screen of the application after the application is first started (FIG. 8), they will then be prompted to enter a password to login to the administration screen (FIG. 13), if a proper password is entered, the admin user is then shown the administration screen (FIG. 14). The administration screen allows a admin user to enter the keyid and tolerance for the application software, clear the READINGS table of data in the database, import the regular baseline readings by way of internet webservice, and also import the simple baseline readings by way of internet webservice.

The administration screen of the custom software application contains the following:
(1) a text field to enter the KeyID
(2) a text field to enter the Tolerance
(3) a button titled UPDATE to enter the KeyID and Tolerance into the database
(4) a button titled CLEAR READINGS to cause the readings data to be deleted
(5) a button titled IMPORT BASELINE to import baseline readings
(6) a button titled IMPORT SIMPLE BASELINE to import simple baseline readings

A text field for the KeyID is displayed on this screen, where the user enters an integer number for the KeyID, the number used as the unique identifier for the phone being used. This is a randomly generated integer number used to identify the phone. The KeyID is unique to a single phone and two phones will not have an identical KeyID. A text field for the Tolerance is also displayed on this screen. In this field a admin user will manually enter the floating point number that will be for the range of vibration measurements tolerated by the application, since there will be a natural variance in the vibration measurements used as baseline and simple baseline readings. The tolerance number is stored in the database table TOLERANCE. The tolerance is manually entered into the phone by the admin user of the software application to prevent the chances of an error or false tolerance value being entered by way of internet webservice. When the admin user clicks the button titled UPDATE on the administration screen of the application, the database table OWNERINFO is checked by a SQL select query to determine if there is already a KeyID stored in the database table. If a record already exists in the database table, then an update of that record with the new KeyID is executed. If no record for KeyID is found in the table, then the KeyID is inserted into the OWNERINFO database table. If the database operation is successful, a confirmation message is displayed to the user with black text on a green background at the bottom of the administration screen. If a database error occurs during the database operation, an error message is displayed to the user in black text on a red background at the bottom of the administration screen of the application. The process for this operation is detailed in the flowchart in FIG. 4.

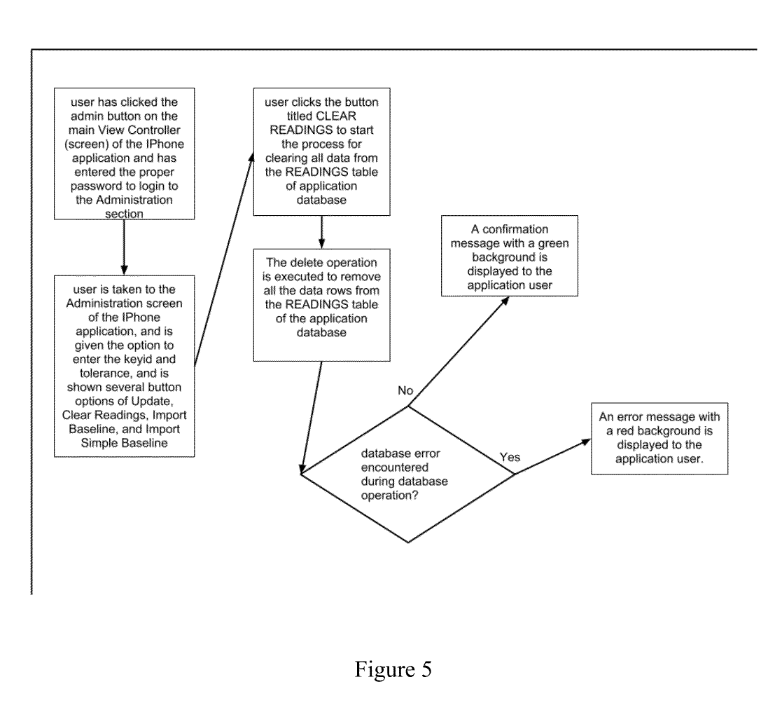

There is a button titled CLEAR READINGS on the administration screen of the software application (FIG. 14). When an admin user clicks this button, a delete sql query is executed on the READINGS database table to remove all rows of data from this database table. This is to allow for cleaning up the database in the event that the database approaches maximum capacity for the amount of data stored. If the database operation is successful, a confirmation message in black text with a green background is displayed at the bottom of the administration screen. If an error is encountered during the database operation, an error message in black text with a red background is displayed at the bottom of the administration screen. The process for this operation is detailed in the flowchart in FIG. 5.

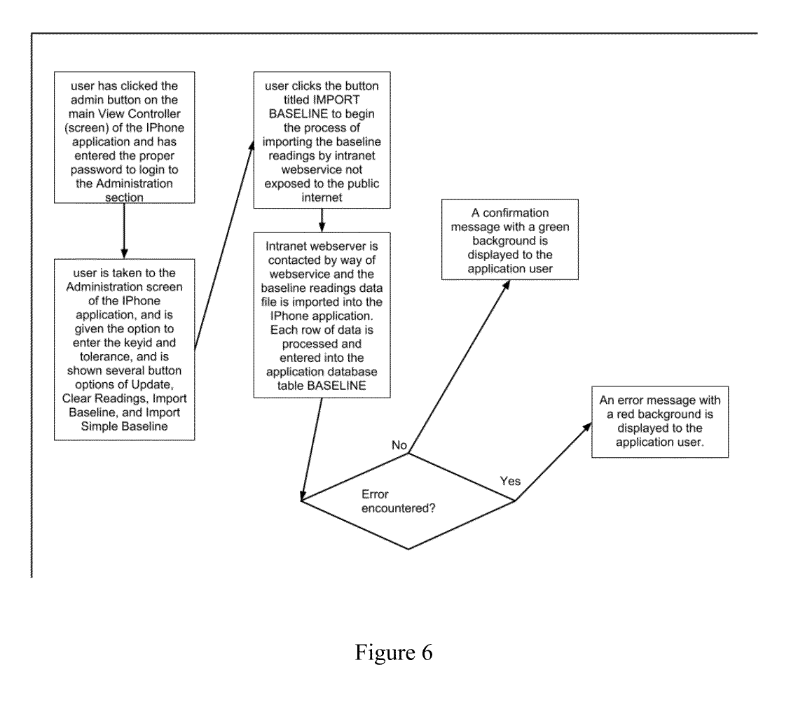

There is a button titled IMPORT BASELINE on the administration screen of the software application (FIG. 14). When the admin user clicks this button a webservice call is made to the central server to get baseline readings to enter into the software application database. To protect the sensitive data that the baseline readings are, this server should only be available on a closed intranet network and the data is not available on the public internet. The server is contacted by internet webservice and a data file is obtained from the server. The data file is a comma separated value (csv) file with each line of data containing the automobile Manufacturer, Type, Part, and Baseline Reading. Each row is processed and entered into the application software database table BASELINE. To prevent duplicate entries of data, if a data record already exists in the database for that Manufacturer, Type, and Part, then that data row is updated instead of a duplicate record being inserted, if no data record exists for that automobile Manufacturer, Type, and Part, then a new data record is inserted into the database. If no error is encountered during these operations, a confirmation message in black text with a green background is displayed on the bottom of the administration screen of the software application. If an error is encountered, an error message in black text with a red background is displayed on the bottom of the administration screen of the software application. The process for this operation is detailed in the flowchart in FIG. 6.

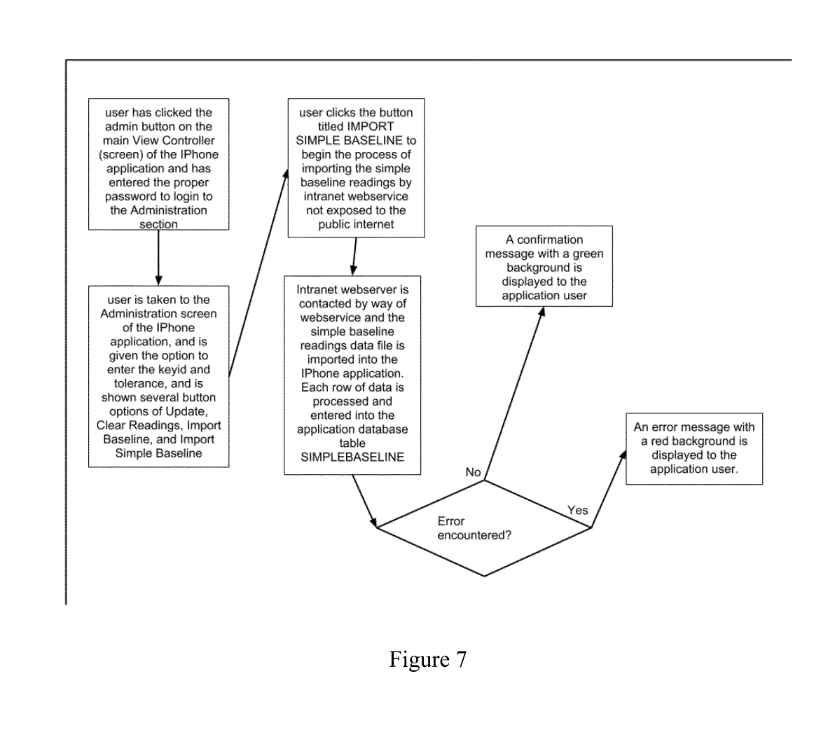

There is a button titled IMPORT SIMPLE BASELINE on the administration screen of the software application (FIG. 14). When the admin user clicks this button a webservice call is made to the central server to get simple baseline readings to enter into the software application database. To protect the sensitive data that the baseline readings are, this server should only be available on a closed intranet network and the data is not available on the public internet. The server is contacted by internet webservice and a data file is obtained from the server. The data file is a comma separated value (csv) file with each line of data containing the automobile Type, Part, and Baseline Reading. Each row is processed and entered into the application software database table SIMPLEBASELINE. To prevent duplicate entries of data, if a data record already exists in the database for that Type and Part, then that data row is updated instead of a duplicate record being inserted, if no data record exists for that automobile Type and Part, then a new data record is inserted into the database. If no error is encountered during these operations, a confirmation message in black text with a green background is displayed on the bottom of the administration screen of the software application. If an error is encountered, an error message in black text with a red background is displayed on the bottom of the administration screen of the software application. The process for this operation is detailed in the flowchart in FIG. 7.

Computer source code for a working implementation of this system and method, and invention, is included as part of this patent application. The computer source code is for software created using the Objective C Programming Language, Extensible Markup Language (XML), and Structured Query Language (SQL). The software was developed using the XCode development environment running on an Apple Macbook computer running operating system Mac OS X version 10.6.8

I claim:

1. A method for detecting hidden materials and/or contraband using an Iphone mobile telephone

2. providing a display that allows the user to select the manufacturer/make of an automobile

3. providing a memory that allows the selected manufacturer/make to be stored by phone

4. providing a display that allows the user to select the color of an automobile

5. providing a memory that allows the selected color to be stored by the phone

6. providing a display that allows the user to designate the type of automobile

7. providing a memory that allows the designated type to be stored by the phone

8. providing a display that allows the user to designate the part of automobile to be examined

9. providing a memory that allows the designated part to be stored by the phone

10. providing a display that displays the manufacturer/make, color, type, and part of the automobile previously selected and designated

11. providing a display that allows the user to click a button, cause the phone to vibrate, apply that vibration to the surface of an automobile, and measure the resulting average vibration using phone accelerometer, the test vibration value.

12. providing a memory to store the average vibration measured by the accelerometer

13. providing a memory to store the latitude and longitude location of the phone

14. providing a memory to store the baseline vibration measurement, the vibration measurement of the surface of an automobile that contains no hidden materials and/or contraband that applies to the manufacturer, type, and part of the automobile

15. providing a memory to store the simple baseline vibration measurement, the vibration measurement of the surface of an automobile that contains no hidden materials and/or contraband that applies to the type and part of the automobile, but not manufacturer.

16. providing a means to compare the vibration measurement of the surface of an automobile, the test vibration, to the baseline vibration measurement of an automobile that contains no hidden materials and/or no contraband

17. providing the means to identify a difference between the test vibration and the baseline vibration measurement to identify hidden materials and/or contraband in the automobile

18. providing the means to identify a difference between the test vibration and the simple baseline vibration measurement to identify hidden materials and/or contraband in the automobile

19. providing the means to report the automobile keyid, latitude, longitude, manufacturer, color, type, part, average vibration measurement, and pass or fail of the automobile test to computer server connected to the internet

20. providing the means to request the manufacturer, type, part and baseline vibration reading of automobiles from a computer server connected to a computer network

21. Providing the means to request the type, part, and simple baseline reading of automobiles from a computer server connected to a computer network

22. providing the memory to store the keyid of the phone

23. providing the memory to store the tolerance value in the phone
